(19) United States
(12) Patent Application Publication
(10) Pub. No.: US 2024/0054523 A1
(43) Pub. Date: Feb. 15, 2024

(54) POINT OF SALE TERMINAL

(71) Applicant: Toshiba Tec Kabushiki Kaisha, Tokyo (JP)

(72) Inventor: Kazuo SHIKANO, Nagoya Aichi (JP)

(21) Appl. No.: 18/360,755

(22) Filed: Jul. 27, 2023

(30) Foreign Application Priority Data
Aug. 10, 2022 (JP) 2022-128125

(51) Int. Cl. G06Q 30/0226; G06Q 30/0238; G06Q 20/20; G06Q 20/28

(52) U.S. Cl. CPC G06Q 30/0233; G06Q 30/0238; G06Q 20/208; G06Q 20/28; G06Q 20/209

(57) ABSTRACT

A point of sale terminal for performing an exchange process through which points can be exchanged for an item, includes a controller configured to determine whether an operation for starting the exchange process is input, upon determining that the operation is input, acquire from a first server the points, upon receipt of an input of an item code of an item, determine whether the item is of a specific type that needs to be activated before use, upon determining that the item is of the specific type, perform an activation process on the item, determine whether the activation process has been successfully performed on the item, calculate points to be exchanged based on whether the activation process has been successfully performed on the item, and control a communication interface to transmit the calculated points to the first server.

### CROSS-REFERENCE TO RELATED APPLICATION(S)

This application is based upon and claims the benefit of priority from Japanese Patent Application No. 2022-128125, filed Aug. 10, 2022, the entire contents of which are incorporated herein by reference.

### FIELD

Embodiments described herein relate generally to a point of sale (POS) terminal, a method carried out by a POS terminal, and a non-transitory computer readable medium.

### BACKGROUND

Conventionally, many stores that sell items or provide services (hereinafter collectively referred to as “sell items”) offer a rewards program that provides rewards or points to registered customers. For example, a store may give a registered customer points at a predetermined ratio to the purchase amount, and the customer may exchange the points given from the store for an item sold by the store.

In recent years, prepaid cards such as point of sale activation (POSA®) cards, which can be used to purchase digital contents, such as application programs, songs, and movies, have been sold in stores. When a prepaid card is purchased, the information identifying the card is sent from a POS terminal to a server managing the issued prepaid cards for activation. The prepaid card becomes usable when it is activated. However, some conventional store systems do not allow the customer to exchange their points to acquire a prepaid card which requires the activation process.

### SUMMARY OF THE INVENTION

Embodiments of the present invention provide a POS terminal or the like capable of exchanging points earned by a customer for a specific item requiring an activation process before use.

A POS terminal for performing an exchange process through which points earned by a customer can be exchanged for an item sold in a store, comprises an input device, a communication interface configured to communicate with a first server that manages the points earned by the customer, and a controller configured to: determine whether an operation for starting the exchange process is input through the input device, upon determining that the operation is input, acquire from the first server the points earned by the customer, upon receipt of an input of an item code of an item through the input device, determine whether the item is of a specific type that needs to be activated before use, upon determining that the item is of the specific type, perform an activation process on the item, determine whether the activation process has been successfully performed on the item, calculate points to be exchanged based on whether the activation process has been successfully performed on the item, and control the communication interface to transmit the calculated points to the first server.

### BRIEF DESCRIPTION OF THE DRAWINGS

FIG. 1 is a schematic diagram of a point system according to an embodiment.

FIG. 2 is a data configuration diagram of a point management file stored in a point management server.

FIG. 3 is a data configuration diagram of a specific item management file stored in a specific item management server.

FIG. 4 is a hardware block diagram of a POS terminal according to an embodiment.

FIG. 5 is a data configuration diagram of item information data stored in the POS terminal.

FIG. 6 is a data configuration diagram of exchange item information data stored in the POS terminal.

FIG. 7 is a data configuration diagram illustrating an item master file stored in the POS terminal.

FIG. 8 is a functional block diagram of the POS terminal.

FIG. 9 is a sequence chart of operations of a point system according to an embodiment.

FIG. 10 is a flowchart of an exchange processing performed by the POS terminal.

### DETAILED DESCRIPTION

Hereinafter, embodiments of this disclosure will be described with reference to the drawings. The present invention is not limited to the embodiments described below.

For example, in the embodiments described below, a POS system including an item data processing apparatus that performs a checkout processing for an item purchased by a customer is described, but the present invention is not limited thereto. The item data processing apparatus may be a dedicated machine used only to exchange points for an item. In the following description, the exchange of points and an item may be referred to as “purchase of an item by points” or “transaction by points”.

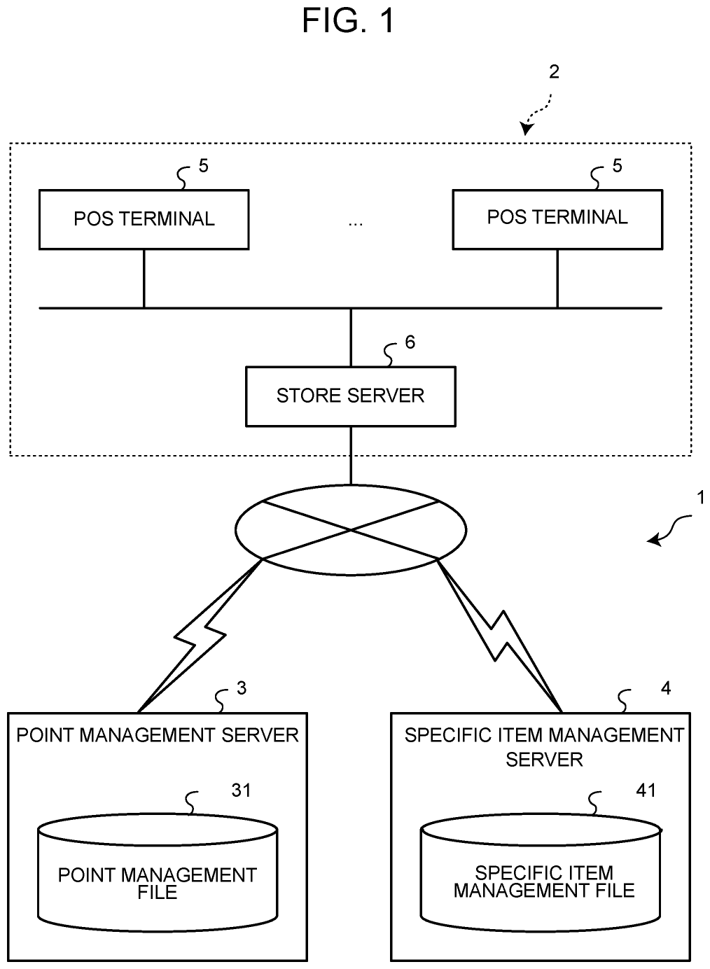

FIG. 1 is a schematic diagram of a point system 1 of an embodiment. The point system 1 is operated by, for example, a store such as a mass retailer that sells prepaid cards such as POSA cards. The point system 1 includes a store system 2, a point management server 3, and a specific item management server 4. The store system 2, the point management server 3, and the specific item management server 4 are communicably connected to each other via a network such as the Internet.

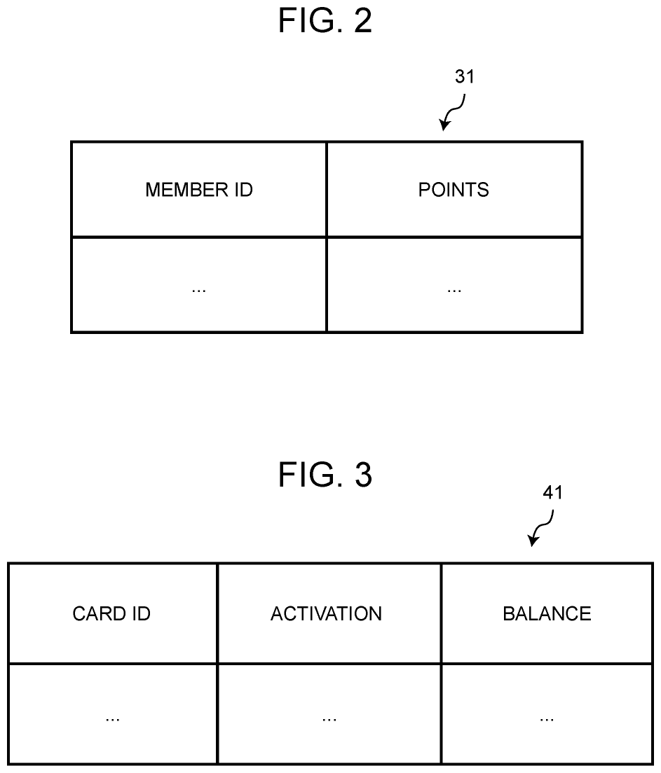

The point management server 3 manages points earned by registered customers. In the present embodiment, the point has a value corresponding to money that can be used in the next and subsequent shopping. Points are granted to a customer according to the customer's purchase amount. The points may be used to pay a portion of the transaction amount or may be used for exchange with an item. The points may be those that can be exchanged for an item or a reward only when a predetermined number of points is reached. FIG. 2 is a data configuration diagram of a point management file 31 stored in the point management server 3. The point management file 31 stores a member ID and points in association with each other. The member ID identifies a registered customer. The points are the ones earned by the customer.

The point management server 3 receives information indicating the points earned in a transaction from a POS terminal 5 via a store server 6, and manages the points for each store customer. Specifically, the point management server 3 receives the member ID indicating the customer of a settled transaction and the points given to the customer in the transaction from the POS terminal 5, and updates the point management file 31. More specifically, in the point management file 31, the point management server 3 adds points received from the POS terminal 5 to the points corresponding to the member ID received from the POS terminal 5.

Further, the point management server 3 receives the member ID of the customer of a settled transaction and information indicating the point used by the customer in the transaction from the POS terminal 5, and updates the point management file 31. More specifically, the point management server 3 subtracts the points received from the POS terminal 5 from the points corresponding to the member ID received from the POS terminal 5 in the point management file 31.

Here, the term “transaction” is a concept including both a case where a customer purchases an item by money and a case where a customer purchases an item by points. In the present embodiment, points are not given to the customer in a transaction by points.

The point management file 31 may be updated every time a payment is made by the POS terminal 5, or may be updated periodically, such as once a day. For example, the point management server 3 receives, from the store server 6, information on points at a rate of one time/day by a batch process of the store server 6 that manages transaction data of the respective POS terminals 5. Then, the point management server 3 can update the point management file 31 based on the information received from the store server 6.

The point management server 3 may manage the points of the customers of one store or may manage the points of the customers of a plurality of stores. In the case of managing the points of the customers of one store, the function of the point management server 3 may be performed by the store server 6. When the points of the customers of the plurality of stores are managed, the points management file 31 further stores a store ID for specifying each store in association with the member ID. The plurality of stores may be operated by the same company or may be a plurality of stores operated by different companies.

The specific item management server 4 manages information of a specific item. The specific item is an item that needs to be activated in a usable state at the time of sale. A prepaid card such as a POSA card is an example of the specific item that needs to be activated. In the present embodiment, the specific item management server 4 manages information of the prepaid cards. FIG. 3 is a data configuration diagram of a specific item management file 41 stored in the specific item management server 4. The specific item management file 41 stores a card ID, activation information, and a balance in association with each other.

The card ID is information for identifying each of the prepaid cards sold in the store, and for example, a serial number or the like is used. The card ID is registered on the basis of the information acquired from the store by the specific item management server 4 when the repaid card is received in the store.

The activation information indicates whether the prepaid card is activated. In the activation information, information indicating “not yet” is registered when the card ID is registered, and when the specific item management server 4 receives an activation request from the POS terminal 5, the activation information is rewritten to information indicating “completed”. The specific item management server 4 executes activation of the prepaid card by rewriting the activation information from “not yet” to “completed”.

The balance is information of the balance of prepaid card. As the balance, the value of the prepaid card is registered when the card ID is registered. Then, the balance is rewritten based on payment information acquired by the specific item management server 4 from an online store or the like at which a payment using the prepaid card has been made.

Next, a store system 2 will be described. The store system 2 is operated by a store that sells a specific item such as a prepaid card. The store system 2 includes one or more POS terminals 5 and store servers 6. Each POS terminal 5 and the store server 6 are communicably connected to each other via a Local Area Network (LAN) or the like.

The POS terminal 5 is operated by a store clerk and performs an item registration process and a checkout process. The POS terminal 5 reads an item code of an item purchased by a customer and stores the item information acquired based on the read item code, thereby executing item registration. Further, the POS terminal 5 executes a checkout process and a receipt issuance process based on the item registered data. The POS terminal 5 may be a self-service POS terminal in which a customer performs the operations related to item registration and checkout processes, or a semi-self-service POS terminal in which a store clerk performs the operation related to an item registration process and a customer performs the operation related to a checkout process.

The checkout process is a process for a customer to make a payment, and includes a calculation process, a payment process, and the like. The calculation process is, for example, a process of calculating a transaction amount. The payment process is a process for completing the payment of the transaction amount calculated in the calculation process, and includes, for example, calculation and payout of change in a cash settlement, and communication with a settlement server in a cashless settlement. The payment process includes a process of giving points to the customer according to the settled amount. The receipt issuance process is a process for issuing a paper receipt or an electronic receipt.

In addition, the POS terminal 5 executes an exchange process. The exchange process is a process executed when a customer purchases an item by points. The details of the exchange process will be described later.

The POS terminal 5 can execute an exchange process related to a specific item that needs to be activated. Specifically, the POS terminal 5 executes an activation process to communicate with the specific item management server 4 in the exchange process of the specific item. The specific item management server 4 receives the identification information of the specific item from the POS terminal 5 and activates the specific item. In addition, the POS terminal 5 executes the point process on the condition that the activation by the specific item management server 4 is executed in the exchange process related to the specific item. The POS terminal 5 performs a point process and communicates with the point management server 3. The point management server 3 updates the points earned by the customer who purchases the specific item by the points. In particular, the points required for exchanging a specific item are subtracted from the points of the customer. The POS terminal 5 is an example of the item data processing apparatus.

The store server 6 receives and manages transaction data settled in checkout processes from the POS terminals 5. The store server 6 centrally manages transaction data received from the POS terminals 5, and performs sales management in one store. Further, the store server 6 appropriately updates an item master file in which the item information of the items sold in the store is stored, and transmit a copy of the item master file to each of the POS terminals 5. The store server 6 transmits various types of information received from the POS terminal 5 to the point management server 3 and the specific item management server 4 as needed. Further, the store server 6 transmits various types of information received from the point management server 3 and the specific item management server 4 to the POS terminal 5.

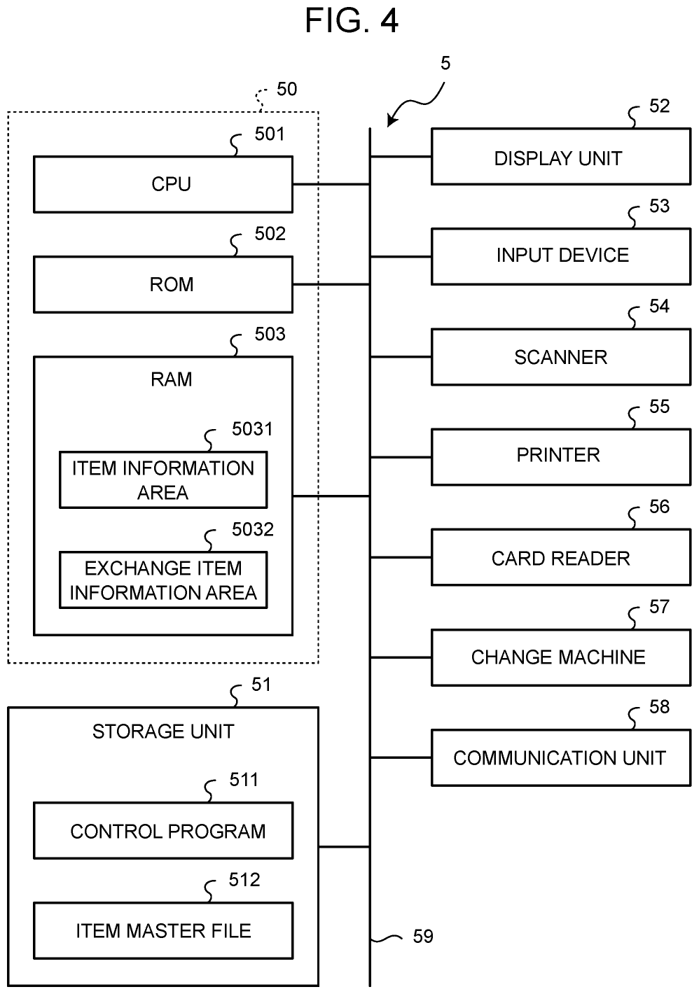

Next, the POS terminal 5 will be described. FIG. 4 is a hardware block diagram of the POS terminal 5. The POS terminal 5 includes a controller 50, a storage unit 51, a display unit 52, an input device 53, a scanner 54, a printer 55, a card reader 56, a change machine 57, and a communication unit 58. The controller 50, the storage unit 51, the display unit 52, the input device 53, the scanner 54, the printer 55, the card reader 56, the change machine 57, and the communication unit 58 are connected to each other via a bus 59 or the like.

The controller 50 includes a central processing unit (CPU) 501, a read only memory (ROM) 502, and a random access memory (RAM) 503. The CPU 501, the ROM 502 and the RAM 503 are connected to each other via the bus 59.

The CPU 501 is a processor that controls the entire operation of the POS terminal 5. The ROM 502 stores various programs such as programs executed by the CPU 501 and various types of data. The RAM 503 is used as a work area of the CPU 501 and stores various programs and various data loaded from the ROM 502 and the storage unit 51. The controller 50 executes various control processes of the POS terminal 5 in accordance with a control program stored in the ROM 502 or the storage unit 51 and loaded onto the RAM 503.

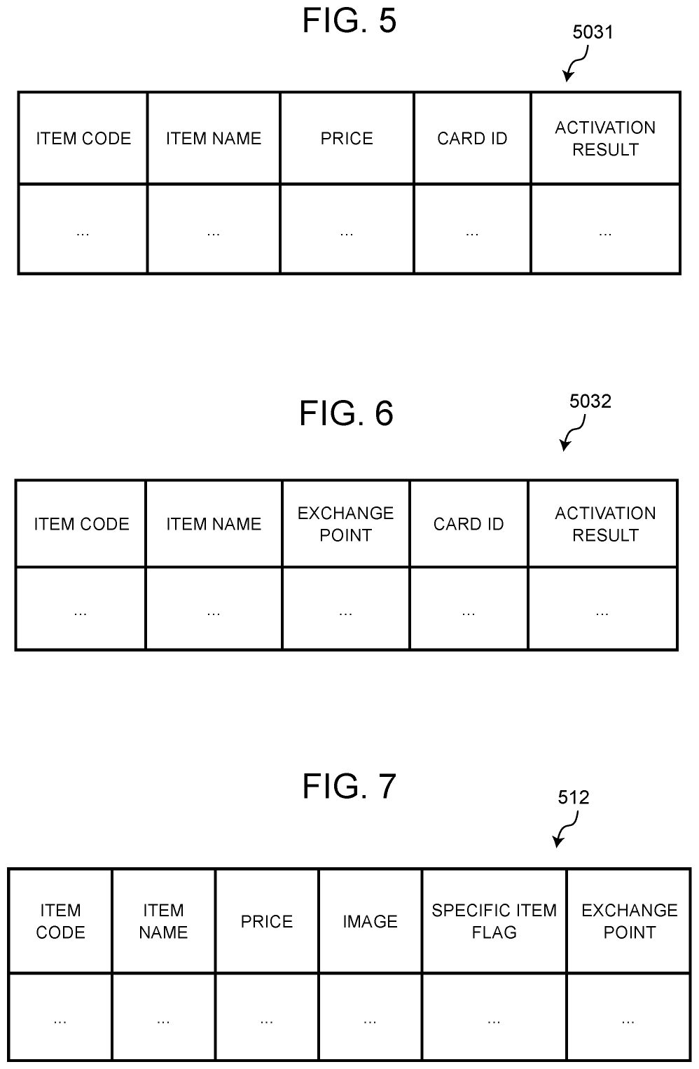

Further, the RAM 503 includes an item information area 5031 and an exchange item information area 5032. The item information area 5031 stores item information of an item purchased by a customer by money. The item information is stored in the item information area 5031 after a transaction start input for declaring a transaction by money is recognized by the controller 50. FIG. 5 is a data configuration diagram of the item information area 5031. The item information area 5031 stores an item name, a price, a card ID, and an activation result in association with an item code.

The item code identifies an item, and is also referred to as the item identification information. The item name indicates the name of the item. The price is information indicating the price of the item. The price of the item may be a tax-inclusive price or a tax-exclusive price. The card ID is used to identify an individual prepaid card. The activation result is information indicating an activation result by the specific item management server 4.

The item name and the price are read from the storage unit 51 based on the item code read from the item bar code attached to the item by the scanner 54, for example. The card ID is read by the scanner 54 from a code symbol attached to a prepaid card separately from the item bar code. The card ID may be input through the input device 53 by the operator. The card ID and the activation result are registered when the item is a specific item.

The exchange item information area 5032 stores item information of an item purchased by a customer by points, that is, an exchanged by points. After the item exchange start input for declaring the transaction by points is made, the item information is stored in the exchange item information area 5032. FIG. 6 is a data configuration diagram of the exchange item information area 5032. The exchange item information area 5032 stores an item name, an exchange point, a card ID, and an activation result in association with an item code.

The item code, the item name, the card ID, and the activation result are the same as those of the item area 5031. The exchange point is information indicating the number of points required to purchase the item by points. The exchange point is read from the storage unit 51 on the basis of, for example, an item code read from an item bar code attached to an item by the scanner 54 in the same manner as the item name and the price. Registration of the item information in the item information area 5031 or the exchange item information area 5032 is also called item registration.

The storage unit 51 is a storage device such as a hard disk drive (HDD) or a flash memory, and maintains the stored data even if the power supply is cut off. The storage unit 51 stores a control program 511 and an item master file 512.

The control program 511 is a program for performing item registration based on an item code read by the scanner 54, a program for performing a checkout process in one transaction based on information stored in the item information area 5031, a program for performing an exchange process based on information stored in the exchange item information area 5032, and the like.

The item master file 512 stores item information of each item sold at a store, and is transmitted from the store server 6 and stored in the storage unit 51. Since the items sold at the store change daily, the item master file 512 is appropriately updated. In a case where the store has an item that can be purchased only by points, in other words, a premium dedicated to point exchange, the item master file 512 also stores information about the premium dedicated to point exchange. FIG. 7 is a data configuration diagram of the item master file 512. The item master file 512 stores an item name, a price, an image, a specific item flag, and an exchange point in association with an item code.

As described above, the item code identifies the item, the item name indicates the name of the item, and the price is the price of the item. The image is image data such as a photograph or an illustration showing the appearance of the item.

The specific item flag indicates whether the item is a specific item. When the item is a specific item, “1” is registered in the specific item flag, and when the item is not a specific item, “0” is registered in the specific item flag. In the present embodiment, “1” is registered in the specific item flag only for a prepaid card.

Note that, in a case where one point is set to a value equivalent to one Japanese yen, the item master file 512 may not store the exchange point. In this case, since the value of the price and the value of the exchange point are the same, the value of the price can be treated as the number of exchange points.

Referring back to FIG. 4, the hardware configuration of the POS terminal 5 will be described.

The display unit 52 is a display device and includes a liquid crystal display or the like. The display unit 52 displays various types of information under the control of the controller 50. For example, the display unit 52 displays the item information of the items registered in a transaction, the transaction amount, and the like. Further, the display unit 52 displays various operation screens for the operator to perform an operation.

The input device 53 includes a touch panel provided on the surface of the display unit 52, a keyboard provided separately from the display unit 52, and the like. The input device 53 accepts various kinds of information input by the operation of the operator to the controller 50. For example, the input device 53 notifies the controller 50 of a transaction start input instructing the start of the checkout process, an item exchange start input instructing the start of the exchange process, and the like. In addition, the input device 53 notifies the controller 50 of a cancellation input of the exchange process selected on the selection screen, and the like.

The scanner 54 reads information from various code symbols shown on media. For example, the scanner 54 reads the item code from the item bar code attached to an item. The scanner 54 reads an item code from an item bar code when a customer purchases an item or exchanges an item for points. Further, the scanner 54 reads a member ID from a bar code displayed on the mobile terminal of a customer. The scanner 54 may be fixed to the POS terminal 5, or may be handheld by an operator.

The printer 55 prints and issues a receipt related to one transaction under the control of the controller 50. The printer 55 prints transaction information including the transaction amount and points awarded in the transaction, various messages, and the like on a receipt.

In addition, the printer 55 prints an error receipt when a customer tries to use a prepaid card that has not been activated. The error receipt is printed with information indicating that the prepaid card has not been activated. A store clerk who is an operator confirms the error receipt and performs necessary steps to solve the error. For example, the store clerk who has checked the error receipt can prepare another prepaid card from the sales area and perform a process for activating the prepaid card.

The card reader 56 reads information from various cards. For example, the card reader 56 reads the customer information required for the credit card payment from the customer's credit card. In addition, the card reader 56 reads the member ID from the member card owned by the customer. The card reader 56 may be a magnetic card reader that reads information from a magnetic card or an IC card reader that reads information from a card with a built-in IC tip.

When the customer pays the purchase price in cash, the change machine 57 accepts bills and coins paid by the customer, and pays out the change as necessary.

The communication unit 58 is a communication interface circuit for communicating with an external device such as the store server 6. The controller 50 is connected to an external device via the communication unit 58, so that information can be transmitted and received to and from the external device. For example, the controller 50 can transmit and receive information to and from the point management server 3 and the specific item management server 4 via the communication unit 58 and the store server 6.

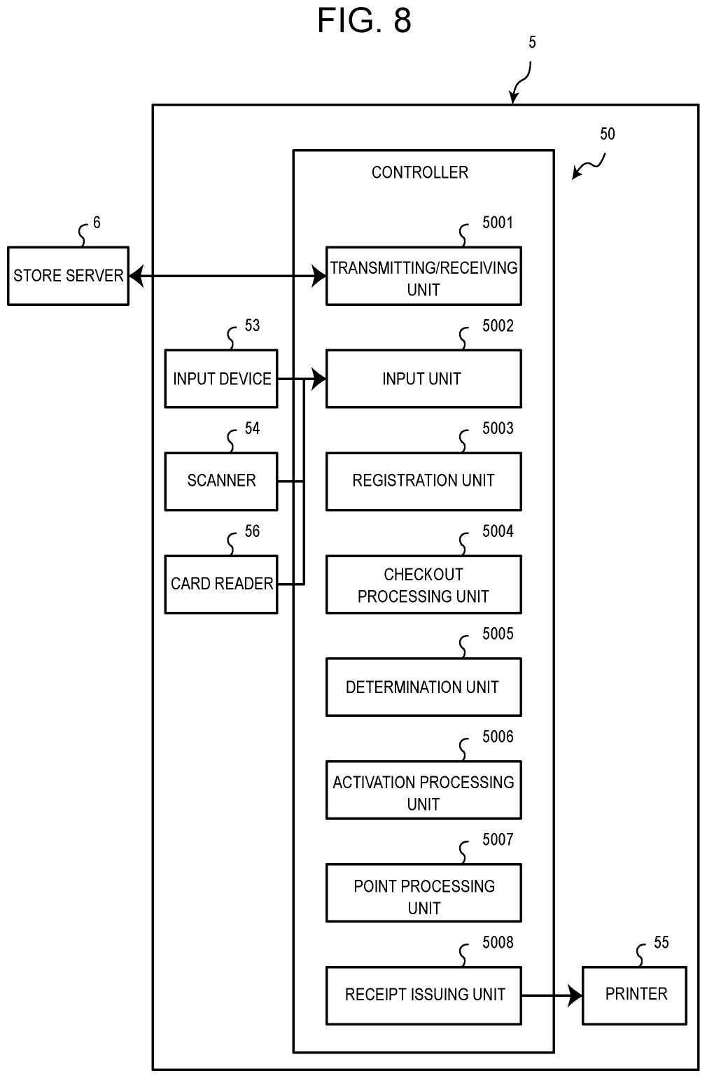

Next, the main functional configuration of the controller 50 of the POS terminal 5 will be described. FIG. 8 is a functional block diagram of the controller 50 of the POS terminal 5. The controller 50 functions as a transmitting/receiving unit 5001, an input unit 5002, a registration unit 5003, a checkout processing unit 5004, a determination unit 5005, an activation processing unit 5006, a point processing unit 5007, and a receipt issuing unit 5008 by executing the control program stored in the ROM 502 or the storage unit 51. Each of these functions may be performed by hardware such as a dedicated circuit.

The transmitting/receiving unit 5001 controls the communication unit 58 to transmit and receive various kinds of information to and from the store server 6. For example, the transmitting/receiving unit 5001 controls the communication unit 58 to receive the item master file 512 from the store server 6. In addition, the transmitting/receiving unit 5001 controls the communication unit 58 to transmit transactional data for each transaction to the store server 6.

The transmitting/receiving unit 5001 controls the communication unit 58 to transmit and receive various kinds of information to and from the point management server 3 and the specific item management server 4 via the store server 6. For example, the transmitting/receiving unit 5001 controls the communication unit 58 to transmit a point query including the member ID input to the input unit 5002 to the point management server 3. Then, the transmitting/receiving unit 5001 controls the communication unit 58 to receive, from the point management server 3, the points earned by the member identified by the transmitted member ID. The transmitting/receiving unit 5001 functions as an acquisition unit that acquires the points held by a customer.

The transmitting/receiving unit 5001 controls the communication unit 58 to transmit, to the point management server 3, a point notification indicating the points given to the customer in a transaction or the points used by the customer in a transaction. Then, the transmitting/receiving unit 5001 controls the communication unit 58 to receive a point update notification indicating the points updated based on the point notification from the point management server 3.

When a customer purchases a prepaid card, the transmitting/receiving unit 5001 controls the communication unit 58 to transmit an activation request including the card ID of the prepaid card to the specific item management server 4. Then, the transmitting/receiving unit 5001 controls the communication unit 58 to receive an activation result from the specific item management server 4. The activation result is information indicating whether the prepaid card has been activated. For example, the activation is not performed when the card ID included in the activation request is not registered in the specific item management file 41 for some reason.

When the store server 6 cannot obtain any activation result due to a communication error between the store server 6 and the specific item management server 4, the transmitting/receiving unit 5001 controls the communication unit 58 to receive an error notification indicating the communication error from the store server 6. The error notification indicating a communication error related to the activation may be processed as a negative activation result. When the POS terminal 5 receives information indicating that activation has not been performed or a negative activation result such as an error notification, the POS terminal 5 determines that the prepaid card requested to be activated is not usable.

Various types of information are input to the input unit 5002 through the input device 53. For example, a transaction start input for declaring the start of a transaction by money, an item exchange start input for declaring the start of a transaction in a point, and the like are input to the input unit 5002 through the input device 53. Further, a confirmation input for confirming a transaction is input to the input unit 5002 through the input device 53.

An item code is input to the input unit 5002 at the time of a transaction by money or at the time of a transaction by points. For example, an item code is read from an item bar code by the scanner 54 or input by the input device 53.

Through the input unit 5002, the member ID for identifying a customer who performs the transaction is input. Specifically, the member ID is read from the bar code displayed on the mobile terminal of the customer by the scanner 54 or the member card of the customer by the card reader 56.

The registration unit 5003 executes item registration. Specifically, the registration unit 5003 reads the item information corresponding to the item code input to the input unit 5002 in a transaction by money from the item master file 512, and registers the item information in the item information area 5031. Further, the registration unit 5003 reads the item information corresponding to the item code input to the input unit 5002 in a transaction by points from the item master file 512, and registers the item information in the exchange item information area 5032.

The checkout processing unit 5004 executes a checkout process related to a transaction. Specifically, the checkout processing unit 5004 calculates, in a transaction by cash, the transaction amount, the points to be given to the customer, and the like on the basis of the information stored in the item information area 5031. Then, the checkout processing unit 5004 executes a payment process for completing the payment of the calculated transaction amount.

When cash payment is selected by the operator, the checkout processing unit 5004 calculates the change by subtracting the transaction amount from the amount of money paid through the change machine 57, and causes the change machine 57 to pay out the calculated change. In addition, in a case where payment by cashless payment such as payment by a credit card is selected by the operator, the checkout processing unit 5004 communicates with a payment server (not shown) via the transmitting/receiving unit 5001 to complete the payment.

The determination unit 5005 determines whether the item identified by the item code input to the input unit 5002 is a specific item that needs to be activated before use. In other words, the determination unit 5005 determines whether the item purchased by the customer is a prepaid card. Specifically, the determination unit 5005 refers to the item master file 512 and determines whether the specific item flag corresponding to the item code input to the input unit 5002 is “1”.

When the determination unit 5005 determines that the item is a specific item, the activation processing unit 5006 executes the activation process. In other words, the activation processing unit 5006 executes the activation process when the item purchased by the customer by money or points is a prepaid card. The activation process executed by the POS terminal 5 to activate a prepaid card.

More specifically, the activation processing unit 5006 reads out, from the item information area 5031 or the exchange item information area 5032, the card ID of the item, i.e., the prepaid card, determined as the specific item by the determination unit 5005. Next, the activation processing unit 5006 causes the transmitting/receiving unit 5001 to transmit an activation request including the read card ID to the specific item management server 4. As a result, the activation processing unit 5006 executes processing required as the POS terminal 5 in order to activate a prepaid card. The activation processing unit 5006 may cause the display unit 52 to perform a display prompting the operator to input the card ID when the item is determined to be a specific item by the determination unit 5005.

The point processing unit 5007 executes a point process related to a transaction. For example, the point processing unit 5007 causes the point management server 3 to transmit a point notification including the points calculated by the checkout processing unit 5004 from the transmitting/receiving unit 5001 in a transaction by money. In addition, the point processing unit 5007 updates the points held by the customer based on the result of the processing by the activation processing unit 5006 in a transaction by points. Here, the result of the processing by the activation processing unit 5006 refers to the result of the activation request by the activation processing unit 5006, the activation result output from the specific item management server 4, and a communication error.

Specifically, the point processing unit 5007 controls the communication unit 58 to transmit a point notification including the exchange point of a prepaid card to the point management server 3 when the activation result received by the transmitting/receiving unit 5001 from the specific item management server 4 is information indicating that the prepaid card has been activated. When the activation result is information indicating that prepaid card has not been activated or information indicating a communication error related to the activation process, the point processing unit 5007 does not control the communication unit 58 to transmit the point notification to the point management server 3.

The receipt issuing unit 5008 controls the printer 55 to issue a paper receipt indicating the details of the transaction. The receipt issuing unit 5008 may issue an electronic receipt indicating the details of the transaction. In this case, the electronic receipt is transmitted from an electronic receipt server (not shown) to the terminal device owned by the customer.

When the item identification information of a plurality of specific items is input to the input unit 5002 and all of the plurality of specific items become usable as a result of the processing by the activation processing unit 5006, the receipt issuing unit 5008 issues a receipt indicating that the point process for all of the plurality of specific items has been executed. In this case, for example, the item name, the exchange points, and the like are printed on the receipt for each of the plurality of specific items. the POS terminal 5 terminates the process related to the transaction by issuing the receipt.

As a result of the processing by the activation processing unit 5006, the receipt issuing unit 5008 issues an error receipt indicating that some of the specific items, i.e., the prepaid cards, are not usable. In this case, for example, the card ID of the prepaid card that has not been activated is printed on the error receipt. At this time, the receipt issuing unit 5008 also issues a receipt indicating that point process for a specific item other than the partial specific item has been executed. In the receipt, for example, the item name, the exchange points, and the like are printed on the activated prepaid card. The POS terminal 5 terminates the process related to the transaction by issuing the error receipt and the receipt.

The receipt issuing unit 5008 does not issue a receipt when all of the plurality of specific items are not usable as a result of the activation process performed by the activation processing unit 5006.

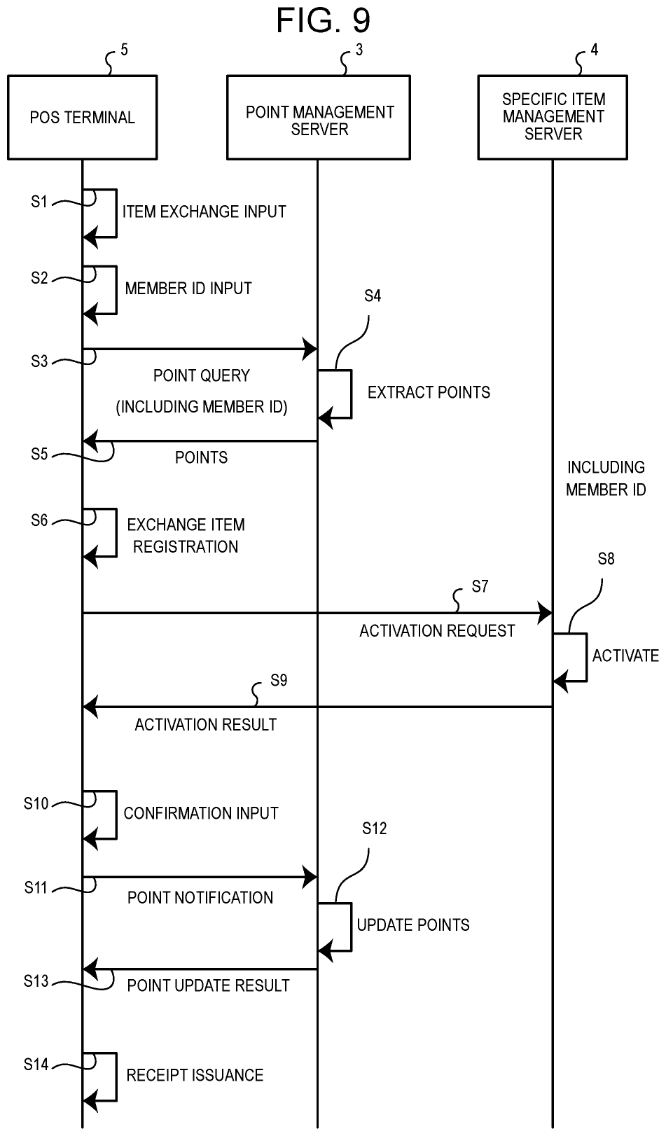

Next, an outline of the operation of the point system 1 having the above-described configuration will be described. FIG. 9 is a sequence chart of an operation of the point system 1 in a transaction by points. Note that the sequence chart shows an operation when the exchange item is a single prepaid card and the prepaid card is activated.

When a transaction by points is performed, an item exchange input is made to the POS terminal 5 by the operator (step S1). Next, the POS terminal 5 receives the member ID of the customer who performs the transaction by points (step S2). The POS terminal 5 transmits a point query including the input member ID to the point management server 3 (step S3). It is assumed that the POS terminal 5 transmits the terminal ID specifying the POS terminal 5 together when transmitting the data to the point management server 3 or the specific item management server 4. As a result, the point management server 3 and the specific item management server 4 can recognize the POS terminal 5, which is the source of the information, and can identify the responding destination to the information from the POS terminal 5.

Upon receiving the point query, the point management server 3 extracts the points held by the customers identified by the member ID included in the point query (step S4). Specifically, the point management server 3 extracts the points corresponding to the member ID included in the received point query from the point management file 31. The point management server 3 transmits the extracted points to the POS terminal 5 which is the source of the point query (step S5).

The operator confirms the points of the customer transmitted from the point management server 3 and causes the scanner 54 to read the item bar code of the exchange item. As a result, the POS terminal 5 performs item registration of the exchange item (step S6). When the exchange item is a specific item, the POS terminal 5 transmits an activation request to the specific item management server 4 for the item registered (step S7). In other words, the POS terminal 5 executes the activation process.

The specific item management server 4 refers to the specific item management file 41 and, if the card ID included in the activation request is registered, rewrites the activation information corresponding to the card ID to “completed”. As a result, activation by the specific item management server 4 is executed (step S8). Then, the specific item management server 4 sets the activation result to “usable”. In addition, the specific item management server 4 refers to the specific item management file 41, and when the card ID included in the activation request is not registered, the activation result is set to “unusable”. The specific item management server 4 transmits the activation result to the POS terminal 5 which is the source of the activation request (step S9).

The operator confirms that the activation result transmitted from the specific item management server 4 is “usable”, and performs a confirmation operation. As a result, a confirmation input is performed to the POS terminal 5 (step S10). The POS terminal 5 notifies the point management server 3 of the exchange point of the activated prepaid card (step S11).

The point management server 3 updates the points based on the received point notification (step S12). Specifically, the point management server 3 refers to the point management file 31 and subtracts the points included in the point notification from the holding point corresponding to the member ID included in the point notification. The point management server 3 transmits the point update result to the POS terminal 5 which is the source of the point notification (step S13). The point update result includes the point used this time and the remaining points.

The POS terminal 5 issues a receipt on which the details of the received point update result is printed (step S14). In the receipt, the used points, the item name of the exchange item for the used points, the remaining points, and the like are printed. In other words, the receipt shows information indicating the point process for subtracting the points has been executed.

These operations allow customers to exchange their own points for a prepaid card that needs to be activated.

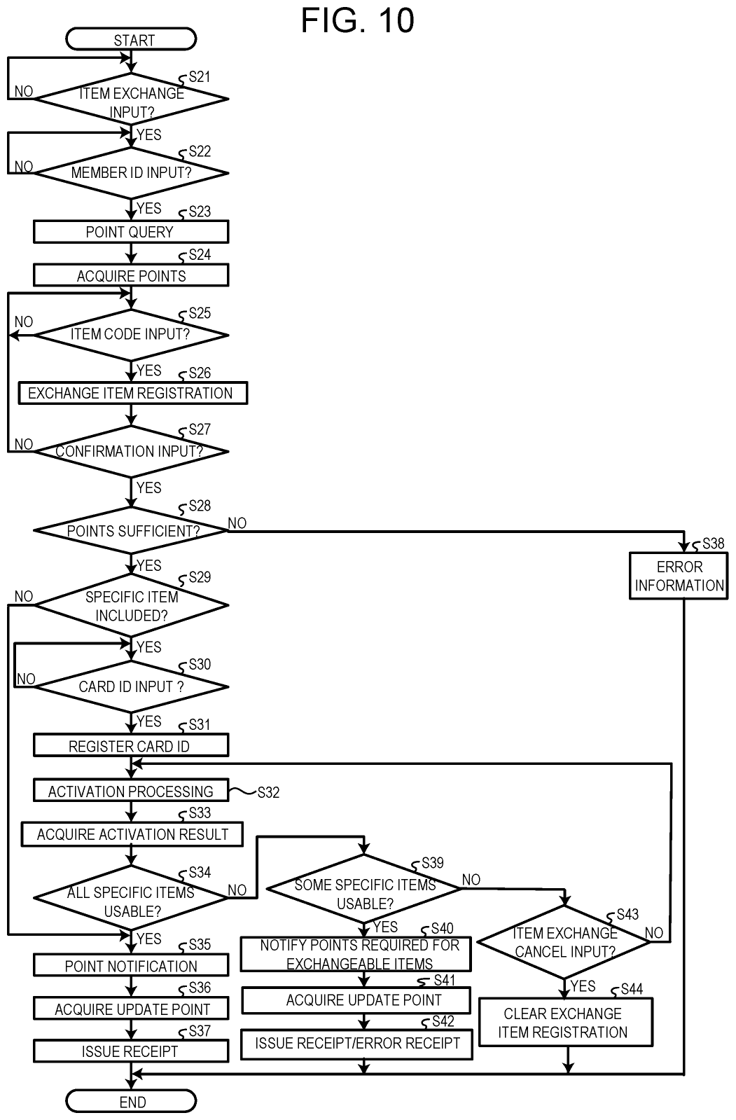

Next, an exchange process executed by the POS terminal 5 will be described. The exchange process is performed when the customer performs a transaction by points. FIG. 10 is a flowchart of the exchange process performed by the controller 50 of the POS terminal 5.

The controller 50 determines whether an item exchange input has been made to the input unit 5002 (step S21), and if not (NO in step S21), returns to the process of step S21 and stands by.

When the item exchange input is made to the input unit 5002 (YES in step S21), the controller 50 determines whether the member ID is input to the input unit 5002 (step S22), and if not (NO in step S22), returns to the process of step S22 and stands by.

When the member ID is input to the input unit 5002 (YES in step S22), the transmitting/receiving unit 5001 controls the communication unit 58 to transmit a point query including the input member ID to the point management server 3 (step S23). In response to the point query, the transmitting/receiving unit 5001 acquires points of the customer specified by the member ID from the point management server 3 (step S24). The acquired points can temporarily be stored in the RAM 503.

Next, the controller 50 determines whether the item code has been input to the input unit 5002 (step S25), and if not (NO in step S25), returns to the process of step S25 and waits. When the item code is input to the input unit 5002 (YES in step S25), the registration unit 5003 executes item registration of the exchange item (step S26). Specifically, the registration unit 5003 reads the item information corresponding to the item code input to the input unit 5002 from the item master file 512, and stores the item information in the exchange item information area 5032. At this time, information is not registered in the activation result of the exchange item information area 5032.

Next, the controller 50 determines whether a confirmation input has been made to the input unit 5002 (step S27), and if not (NO in step S27), returns to the process of step S25. Then, the controller 50 waits until the next item code is input. When a confirmation input is made to the input unit 5002 (YES in step S27), the controller 50 determines whether the number of points is sufficient (step S28). That is, the controller 50 compares the sum of the exchange points of all the exchange items registered in the exchange item information area 5032 with the holding points of the customers acquired in the step S24.

When the points are sufficient (YES in the step S28), that is, when the points of the customer are equal to or more than the sum of the exchange points of all the exchange items, the determination unit 5005 determines whether there is a specific item in the exchange items registered in the exchange item information area 5032 (step S29). Specifically, the determination unit 5005 determines whether there is an exchange item in which “1” is registered in the specific item flag of the item master file 512 among the exchange items registered in the exchange item information area 5032.

When there is a specific item in the exchange item registered in the exchange item information area 5032 (YES in step S29), the controller 50 determines whether a card ID has been input to the input unit 5002 (step S30), and if it is not input (NO in step S30), returns to step S30 and stands by.

When the card ID is input to the input unit 5002 (YES in step S30), the registration unit 5003 registers the card ID in the exchange item information area 5032 (step S31). Next, the activation processing unit 5006 executes the activation process (step S32). Specifically, the activation processing unit 5006 reads the card ID from the exchange item information area 5032, and causes the transmitting/receiving unit 5001 to control the communication unit 58 to transmit an activation request including the read card ID to the specific item management server 4.

The transmitting/receiving unit 5001 acquires the activation result (step S33). For example, the transmitting/receiving unit 5001 acquires, as a response to the activation request, the activation result of the prepaid card specified by the card ID from the specific item management server 4. Alternatively, the transmitting/receiving unit 5001 acquires an error notification indicating a communication error from the store server 6. The controller 50 determines whether all prepaid cards have been activated and become usable as a result of the process by the activation process (step S34).

When all repaid cards become usable (YES in step S34), the point processing unit 5007 controls the communication unit 58 to transmit a point notification to the point management server 3 (step S35). The point notification includes the sum of the points to be exchanged for all prepaid cards. The transmitting/receiving unit 5001 acquires the update points from the point management server 3 (step S36). The update points indicate the points used to purchase the prepaid cards and the points that the customer earns after the purchase of the prepaid cards.

Next, the receipt issuing unit 5008 issues a receipt (step S37). In the receipt, for example, the item name, the card ID, the exchange points, and the like are printed for each of the plurality of prepaid cards. Then, the controller 50 ends the exchange process.

In the step S28, when the number of points is insufficient (NO in the step S28), the controller 50 causes the display unit 52 to display the error information (step S38). The error information indicates that the number of points of the customer who intends to purchase the item by the points is insufficient. Then, the controller 50 ends the exchange process. In the process of the step S29, when there is no specific item (NO in the step S29), the controller 50 proceeds to the process of the step S35.

In the process of the step S34, when there is an unusable prepaid card (NO in the step S34), the controller 50 determines whether only some of the prepaid cards are usable as a result of the activation process (step S39). Here, the prepaid card that is not usable is, for example, one in which the card ID is not registered in the specific item management file 41.

When only some of prepaid cards become usable (YES in the step S39), the point processing unit 5007 controls the communication unit 58 to transmit a point notification regarding the prepaid card that is exchangeable to the point management server 3 (step S40). The point notification includes the sum point of the exchange point of the prepaid cards that have become available. The transmitting/receiving unit 5001 acquires the update points from the point management server 3 (step S41). The update points indicate the points used to purchase the prepaid card and the points that the customer earns after the purchase of the prepaid card.

Next, the receipt issuing unit 5008 issues a receipt and an error receipt (step S42). In the receipt, for example, the item name, the card ID, the exchange points, and the like are printed on each of the prepaid cards that has become usable. In the error receipt, the item name, the card ID, the exchange points, and the like are printed on the prepaid card that is not usable. Then, the controller 50 ends the exchange process.

In the process of the step S39, when only some of the prepaid cards are not usable (NO in the step S39), in other words, when all of the POSA cards are not usable, the controller 50 determines whether an item exchange cancel input is input to the input unit 5002 (step S43). The item exchange cancel input is input by the operator operating the input device 53.

When the item exchange cancel input is input to the input unit 5002 (YES in step S43), the registration unit 5003 clears the information of the registered exchange item (step S44). Specifically, the registration unit 5003 clears the item information registered in the exchange item information area 5032. Then, the controller 50 ends the exchange process.

When the item exchange cancel input is not input to the input unit 5002 (NO in step S43), the controller 50 returns to the process of step S32. When all of the registered prepaid cards are not usable, it is assumed that a temporary communication error has occurred between the POS terminal 5 and the specific item management server 4, and therefore, when the item exchange cancellation input is not made, the activation processing unit 5006 retries the activation process. In other words, when all of the registered prepaid cards are not usable, the controller 50 does not terminate the exchange process until the item exchange cancel input is input to the input unit 5002.

By the above-described exchange process, the customer can also purchase a specific item such as a prepaid card by points. Moreover, on the condition that the prepaid card is activated, a point process is performed to subtract the exchange points of the prepaid card. For this reason, the point process of the prepaid card that has not been activated does not occur again. Specifically, if the prepaid card is not activated after performing the point process and subtracting the exchange points of the prepaid card from the customer's points, the processing of returning the subtracted points is required, but in the present embodiment, the processing of returning the points does not occur. Therefore, it is possible to prevent the operator's operation from becoming complicated.

As described above, the POS terminal 5 includes the transmitting/receiving unit 5001 for acquiring the points owned by the customer, the input unit 5002 for inputting the item identification code of the exchange item to be exchanged with the points acquired by the transmitting/receiving unit 5001, the determination unit 5005 for determining whether the exchange item identified by the item code input to the input unit 5002 is a specific item that needs to be activated to enable the exchange item to be used, the activation processing unit 5006 for executing a process for activating the exchange item when the determination unit 5005 determines that the exchange item is a specific item, and the point processing unit 5007 for executing a point process for updating the points owned by the customer based on a result of the process performed by the activation processing unit 5006.

This allows a customer to use the POS terminal 5 to exchange his or her points for a specific item that needs to be activated. Therefore, it is possible to expand the servicing of the store in which the POS terminal 5 is installed.

Further, in the POS terminal 5, the point processing unit 5007 executes a point process for subtracting the points exchanged for the specific item on condition that the specific item becomes usable as a result of the processing by the activation processing unit 5006.

As a result, the POS terminal 5 does not redo the pointing process for the specific item that has not been activated. Therefore, the POS terminal 5 can prevent the operator from being operated in a complicated manner.

Further, the POS terminal 5 further includes a receipt issuing unit 5008 that issues a receipt indicating that the point process for all of the plurality of specific items has been executed when the item codes of the plurality of specific items are input to the input unit 5002 and all of the plurality of specific items become usable as a result of the processing by the activation processing unit 5006.

Thus, when all of the specific items that the customer intends to purchase by the point are activated and become usable, the operator can recognize that the necessary point process has been performed by checking the issued receipt.

In addition, in the POS terminal 5, the receipt issuing unit 5008 issues an error receipt indicating that the part of the specific item is not usable and a receipt indicating the point process related to the specific item other than the part of the specific item is executed, when a part of the plurality of specific items is not usable as a result of the process performed by the activation processing unit 5006.

By checking the issued receipt and the error receipt, the operator can recognize that activation has not been performed for some specific items and that necessary processing has been performed for specific items other than some specific items.

Further, in the POS terminal 5, the receipt issuing unit 5008 does not issue a receipt when all of the plurality of specified items are not usable as a result of the process performed by the activation processing unit 5006.

As a result, the POS terminal 5 can cause the operator to recognize that the process related to the transaction by points has not been completed, for example, when the activation of all the specified items has not been performed due to a temporary communication error. Therefore, the operator can retry the activation process by performing the necessary operation.

In the above-described embodiments, the control program executed by the POS terminal 5 may be recorded in a non-transitory computer-readable recording medium such as a CD-ROM. Further, the control program executed by the POS terminal 5 may be stored in a computer connected to a network such as the Internet, and may be downloaded via a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A point of sale (POS) terminal for performing an exchange process through which points earned by a customer can be exchanged for an item sold in a store, comprising:
an input device;
a communication interface configured to communicate with a first server that manages the points earned by the customer; and
a controller configured to:
determine whether an operation for starting the exchange process is input through the input device;
upon determining that the operation is input, acquire from the first server the points earned by the customer;
upon receipt of an input of an item code of an item through the input device, determine whether the item is of a specific type that needs to be activated before use;
upon determining that the item is of the specific type, perform an activation process on the item;
determine whether the activation process has been successfully performed on the item;
calculate points to be exchanged based on whether the activation process has been successfully performed on the item; and
control the communication interface to transmit the calculated points to the first server.

2. The POS terminal according to claim 1, wherein the item is a prepaid card.

3. The POS terminal according to claim 1, wherein the calculated points are predetermined points required for the item when the activation process has been successfully performed.

4. The POS terminal according to claim 1, wherein the calculated points are zero when the activation process has not been successfully performed.

5. The POS terminal according to claim 1, further comprising:
a printer, wherein
the controller is configured to control the printer to issue a receipt on which the points to be exchanged are printed.

6. The POS terminal according to claim 5, wherein the receipt indicates whether the activation process has not been successfully performed on the item.

7. The POS terminal according to claim 5, wherein the controller controls the printer to issue the receipt only when the activation process has been successfully performed.

8. The POS terminal according to claim 1, further comprising:
a printer, wherein
the controller is configured to, when the activation process is performed on a plurality of items, control the printer to issue:
a first receipt indicating one or more items on which the activation process has been successfully performed and
a second receipt indication one or more items on which the activation process has not been successfully performed.

9. The POS terminal according to claim 1, wherein
the communication interface is configured to communicate with a second server that manages activation status of each of a plurality of items of the specific type, and
the controller is configured to, after determining that the item is of the specific type,
acquire an identification code of the item,
control the communication interface to transmit to the second server the identification code by which the second server performs the activation process on the item, and
acquire a result of the activation process from the second server, and
the controller determines whether the activation process has been successfully performed based on the acquired result.

10. The POS terminal according to claim 9, wherein the controller is configured to retry the activation process when the result indicates that a communication error has occurred between the POS terminal and the second server.

11. A method carried out by a point of sale (POS) terminal for performing an exchange process through which points earned by a customer can be exchanged for an item sold in a store, the method comprising:
determining whether an operation for starting the exchange process is input;
upon determining that the operation is input, acquiring from a first server the points earned by the customer;
upon receipt of an input of an item code of an item, determining whether the item is of a specific type that needs to be activated before use;
upon determining that the item is of the specific type, performing an activation process on the item;
determining whether the activation process has been successfully performed on the item;
calculating points to be exchanged based on whether the activation process has been successfully performed on the item; and
transmitting the calculated points to the first server.

12. The method according to claim 11, wherein the item is a prepaid card.

13. The method according to claim 11, wherein the calculated points are predetermined points required for the item when the activation process has been successfully performed.

14. The method according to claim 11, wherein the calculated points are zero when the activation process has not been successfully performed.

15. The method according to claim 11, further comprising:
issuing a receipt on which the points to be exchanged are printed.

16. The method according to claim 15, wherein the receipt indicates whether the activation process has not been successfully performed on the item.

17. The method according to claim 15, wherein the receipt is issued only when the activation process has been successfully performed.

18. The method according to claim 11, further comprising:
when the activation process is performed on a plurality of items, issuing:
a first receipt indicating one or more items on which the activation process has been successfully performed and
a second receipt indication one or more items on which the activation process has not been successfully performed.

19. The method according to claim 11, further comprising:
after determining that the item is of the specific type,
acquiring an identification code of the item,
transmitting to a second server the identification code for performing the activation process on the item, and
acquiring a result of the activation process from the second server, wherein
whether the activation process has been successfully performed is determined based on the acquired result.

20. A non-transitory computer readable medium storing a program causing a computer to execute a method for performing an exchange process through which points earned by a customer can be exchanged for an item sold in a store, the method comprising:
determining whether an operation for starting the exchange process is input;
upon determining that the operation is input, acquiring from a first server the points earned by the customer;
upon receipt of an input of an item code of an item, determining whether the item is of a specific type that needs to be activated before use;
upon determining that the item is of the specific type, performing an activation process on the item;
determining whether the activation process has been successfully performed on the item;
calculating points to be exchanged based on whether the activation process has been successfully performed on the item; and
transmitting the calculated points to the first server.
